(19) United States
(12) Patent Application Publication
(10) Pub. No.: US 2019/0087706 A1
(43) Pub. Date: Mar. 21, 2019

(54) DUAL TAG NEAR FIELD COMMUNICATION AUTHENTICATION SYSTEM AND METHOD

(71) Applicant: Kyle Bermel, Clear Lake, IA (US)

(72) Inventor: Kyle Bermel, Clear Lake, IA (US)

(21) Appl. No.: 16/136,364

(22) Filed: Sep. 20, 2018

Related U.S. Application Data
(60) Provisional application No. 62/561,099, filed on Sep. 20, 2017.

(51) Int. Cl. G06K 19/077; G06K 7/10

(52) U.S. Cl. CPC G06K 19/07766; G06K 7/10386; G06K 19/07758

(57) ABSTRACT

Example embodiments relate to an authentication system and a method of authenticating a product.

### CROSS-REFERENCE TO RELATED APPLICATION(S)

This application claims the benefit of U.S. Provisional Patent Application No. 62/561,099 filed with the United States Patent and Trademark Office on Sep. 20, 2017, the entire contents of which is herein incorporated by reference.

### BACKGROUND

### 1. Field

Example embodiments relate to an authentication system and a method of authenticating a product.

### 2. Description of the Related Art

In the United States counterfeit goods cost consumers and manufacturers billions of dollars a year. High end shoes, for example, are often counterfeited. In this industry it is not unusual for a counterfeiter to match a bona fide shoe with a counterfeit shoe and sell the pair as a bona fide pair of shoes.

### SUMMARY

In view of problems with counterfeiting, the inventor set out to devise a method in which counterfeit items may be detected. As a consequence, the inventor invented a new method of authenticating a product and/or service for purposes of detecting counterfeits. However, the invention has purposes outside of counterfeit detection. As such, while counterfeit detection is certainly a problem addressable by the inventor's invention, the invention is not limited thereto.

### BRIEF DESCRIPTION OF THE DRAWINGS

Example embodiments are described in detail below with reference to the attached drawing figures, wherein:

FIG. 1 is a view of a tag in accordance with example embodiments;

FIG. 2 is a view of a computing device in accordance with example embodiments;

FIG. 3 is a view of a system in accordance with example embodiments;

FIG. 4 is a view of an association table in accordance with example embodiments;

FIG. 5 is a view of a system in accordance with example embodiments;

FIG. 6 is a view of a system in accordance with example embodiments;

FIG. 7 is a view of a system in accordance with example embodiments;

FIG. 8 is a flowchart of a method in accordance with example embodiment;

FIG. 9 is a view of an association table in accordance with example embodiments; and

FIG. 10 is a view of a system in accordance with example embodiments.

### DETAILED DESCRIPTION

Example embodiments will now be described more fully with reference to the accompanying drawings. Example embodiments are not intended to limit the invention since the invention may be embodied in different forms. Rather, the example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature only as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example Embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to an authentication system and a method of authenticating a product.

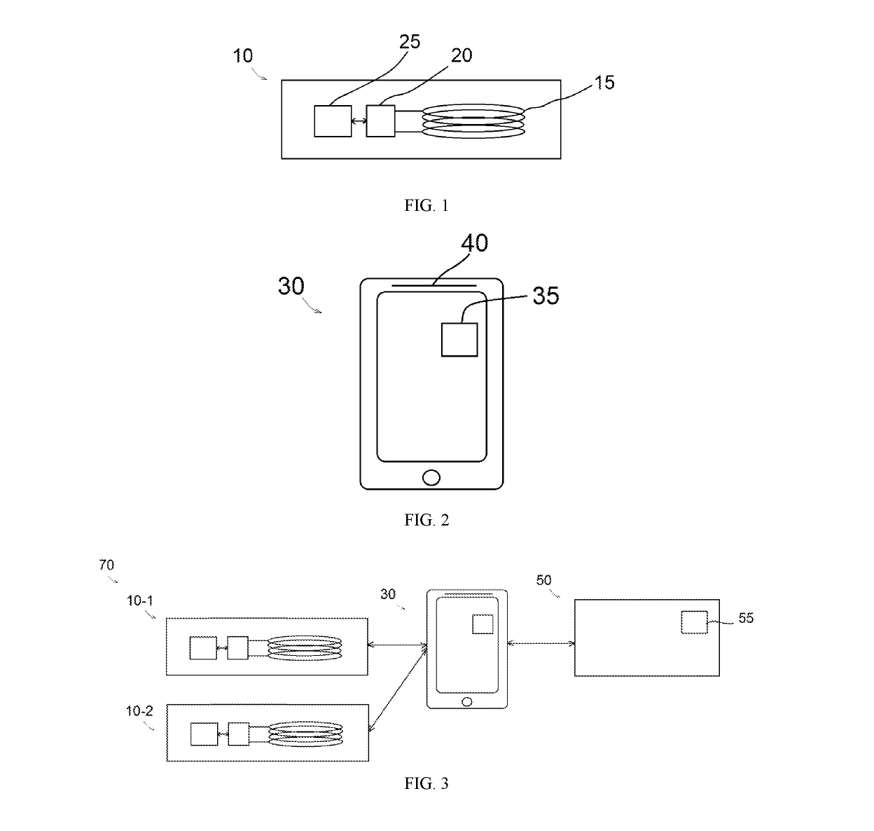

FIG. 1 illustrates an example of a tag 10 usable with example embodiments. In FIG. 1 the tag 10 may be an RFID tag 10 as is well known in the art. In one nonlimiting example embodiment the tag 10 may be an active RFID tag, in another embodiment, the tag 10 may be a passive RFID tag. Because the architecture of passive and active RFID tags are well known, a detailed description thereof is omitted for the sake of brevity.

In example embodiments the tag 10 may have an ability to communicate with a device. In one nonlimiting example embodiment, for example, the tag may have Near Field Communication (NFC) capability. As one skilled in the art would readily appreciate, NFC is a set of communication protocols that enable two electronic devices to establish communication by bringing them within 1.6 inches of each other. Although example embodiments utilize NFC communication it is understood NFC communication is only an example of communication protocol which may be implemented by the invention as the invention may utilize other methods of wireless communication.

In FIG. 1, the tag 10 may include an antenna 15, for example, an NFC antenna, which may receive a signal from an external source. The antenna 15 may be connected to an electronic controller 20 which may be configured to execute one or more functions in response to a signal received by the antenna 15. For example, in one nonlimiting example embodiment, the tag 10 may include an id, which may be a unique id, stored in an electronic chip 25 and the controller 20 may be configured to transmit the id, via the antenna 15, to an external device in response to a signal received by the antenna 15. In example embodiments, the tag 10 may be an active or passive RFID tag 10. Thus, the tag 10 may include a power source, for example, a battery, or a circuit which may be energized by an interrogating wave. In the following description each of the tags may include an antenna, a processor, and an electronic chip and thus may be NFC enabled tags capable of sending an id. Also, it is understood that while the figures illustrate the tag 10 as having an electronic chip 25 and controller 20 as separate components, in example embodiments the electronic chip 25 and controller 20 may alternatively be embodied in a single circuit or a single chip which is configured to send the tag's unique identifier upon receiving an interrogating NFC signal.

In example embodiments, the antenna 15 may receive an RF signal from an external NFC reader (for example a computing device 30). In at least one example embodiment, the antenna 15 provides power to the circuit. Specifically, the antenna 15 may have a current induced therein when placed in proximity to an NFC signal reader.

FIG. 2 illustrates an example of a computing device 30. The computing device 30 may include a processor 35 and an antenna 40 and may be configured to receive electronic information, for example, an id, from a tag. In example embodiments, the computing device 30 may initiate NFC communication with a tag which prompts the tag to send its id to the computing device 30. The computing device may then send this data to a computer 50 which may use this data in an authentication process. In example embodiments the computing device 30 may be a hand held device, for example, a smart phone, a tablet, or an i-pad, and may be configured to both send and receive information as well as execute applications and/or computer programs. In example embodiments, a person may move the computing device 30 near the tag 10 in order to provoke the tag 10 to send its id to the computing device 30.

FIG. 3 illustrates an example of a system 70 which includes a first tag 10-1, a second tag 10-2, the computing device 30, and the computer 50. In this nonlimiting example embodiment each of the tags 10-1 and 10-2 may include the circuitry of tag 10. As such, the tags 10-1 and 10-2 may be NFC enable tags each having a unique id. In example embodiments the computing device 30 may be connected to the computer 50 via the internet or some other network. Because the internet and networks are well known, a description thereof is omitted for the sake of brevity.

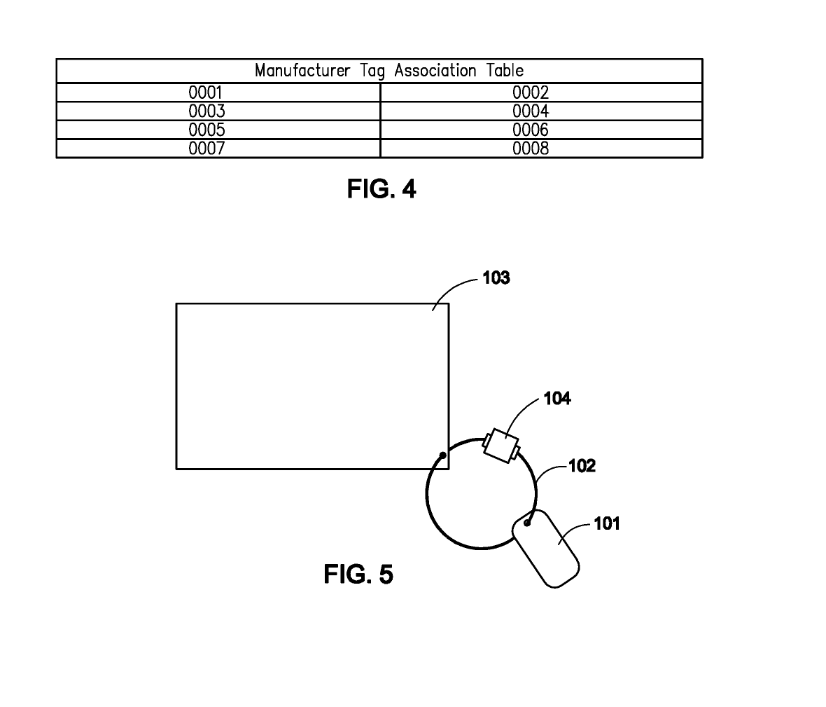

In example embodiments, the computer 50 may be used in an authentication routine. For example, the computer 50 may maintain a database 55, see FIG. 4, which may store a list of associated ids for purposes of authentication. For example, a manager of system 70 may determine that a tag having the id of 0001 should be associated with a tag having an id of 0002. Similarly, the manager of system 70 may determine that a tag having an id of 0003 should be associated with a tag having an id of 0004. Similar yet, a manager of a system may determine that a tag having an id of 0005 should be associated with a tag having an id of 0006. Similar yet, a manager may determine that a tag having an id of 0007 should be associated with a tag having an id of 0008. These associations may be stored in the electronic database 55 (also called an authentication table) and may be used in an authentication program as described below.

FIG. 5, illustrates a system in which various inventive concepts may be illustrated. As shown in FIG. 5, the system may include a product 103 with a first tag 101 attached to the product 103. The first tag 101 may be affixed to the product 103 using a multitude of different attachment methods. For example, an NFC enabled mechanical fastener 102, with an NFC chip 104, is shown affixed to the product 103. The NFC chip 104 may be attached to the mechanical fastener 102. In example embodiments, the first tag 101 may include the circuitry of the previously described tag 10 and thus may be an enabled NFC tag. In this nonlimiting example embodiment, the NFC enabled fastener 102 and the NFC enabled tag 101 may each include an id (each of which may be unique) and each of the NFC enabled fastener 102 and the NFC enabled tag 101 may be configured to send its id to a computing device 30 when the computing device 30 communicates therewith. For example, the id of the NFC enabled fastener 102 may be 0001 and the id of the NFC enabled first tag 101 may be 0002. In this example, the computing device 30, may be moved near the NFC enabled fastener 102 to send an RF signal to the fastener 102 to cause the fastener 104 to send its id to the computing device 30 (this action may also cause the computing device to execute an application to facilitate an authentication process). The computing device 30, after receiving the id from the fastener 102, may send this information to the computer 50. The computing device 30 may then communicate with the NFC enabled tag 101 (by moving the computing device 30 in proximity to the NFC enabled tag 101) thus causing the tag 101 to send its id to the computing device 30. The computing device 30, in turn, may send this unique id to the computer 50. The computer 50 may then compare the pair of ids to the association table 55 to determine whether the first tag 101 and the NFC mechanical fastener 102 should be associated with each other. In the present example, the computer 50 would determine that the sensed tag 101, having the id of 0002, and the sensed fastener 102, having the id 0001 are properly together since their associations are present in the association table 55 of FIG. 4. On the other hand, if the id of the fastener 102 was 0004, rather than 0001, then the computer 50 would determine that the tag and 101 and fastener 102 do not belong together since this particular id pair is not listed in the association table 55. Thus, in the former example, the computer 50 would authenticate the tag 101 with the fastener 102 whereas in the latter example it would not.

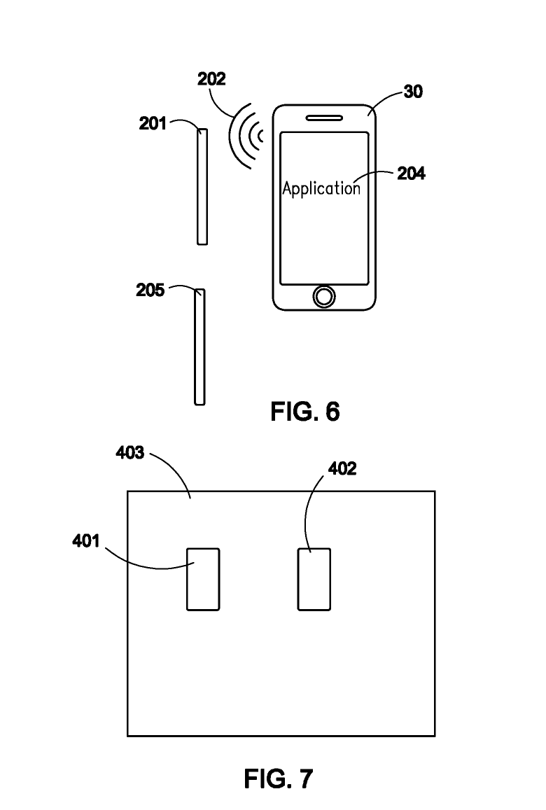

FIG. 6 illutrates a first tag 201 being tapped 202 by a computing device 30. The communication 202 between the first tag 201 and the computing device 30 may cause the computing device 30 to launch an application 204 and also retrieve the unique identifier from the first tag 201. The application 204, after launching and retrieving the identifier from the first tag 201, may prompt the user to tap a second tag 205 which causes the second tag 205 to send its id to the computing device 30. The computing device may send the pair of ids to the computer 50 to perform the authentication process as described above.

FIG. 7 illustrates another embodiment where a first tag 401 and a second tag 402 are affixed to an element 403 using a different attachment method. For example, each of the first and second tags 401 and 402 may be attached to the element via an adhesive. In example embodiments, a computing device 30 may tap the first tag to retrieve its id and the second tag 402 to retrieve its id. The pair of ids may then be sent to computer 50 for authentication.

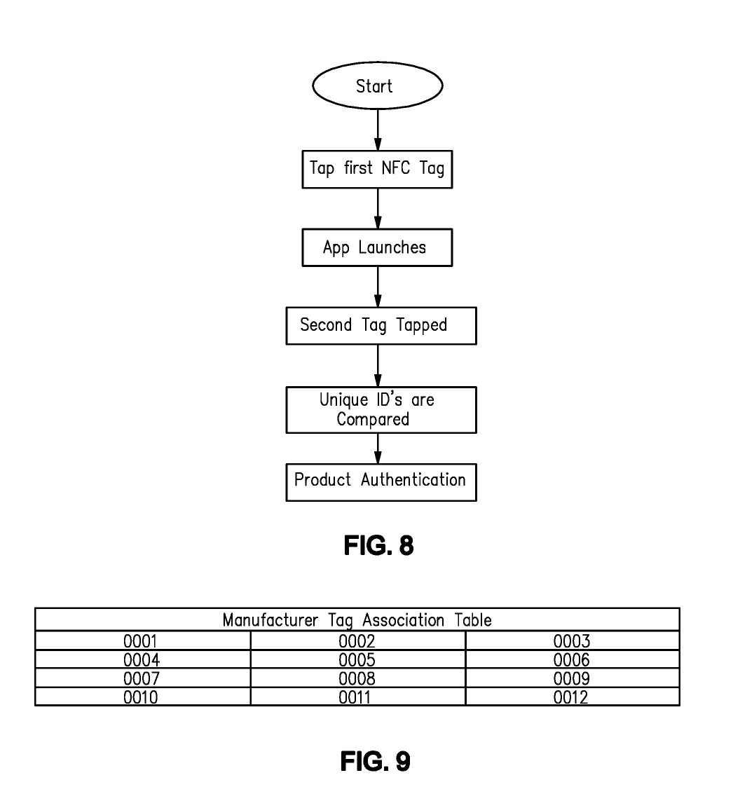

FIG. 8 illustrates a flow chart of a process 501. The process begins with step 502 tapping a first NFC tag. At step 503 an application launches and the unique identifier of said first NFC tag is recorded. The application then requests the user to tap the second NFC tag at step 504. Upon executing step 504, the unique identifier of said second NFC tag is recorded. Following the recording of the two unique identifiers, the unique identifiers are compared to authenticated pairs of identifiers, at step 505, to determine whether the tag one of step 502 and the tag two of step 504 are properly associated. When the two unique are determined to be to be an authenticated pair of identifiers, the product is authenticated, step 506.

The above system may be utilized across various industries. For example, a shoe manufacture may create and tag various pairs of shoes. In this example, each shoe may have a tag attached thereto and the pair of tags for the pair of shoes may be recorded in an authentication table prepared by the manufacturer. In this example the shoes may be shipped to various outlets for sale. If a party were to purchase a pair of shoes and return the shoes to a reseller for a refund the reseller may utilize the above described system to ensure the shoes returned by the purchaser were the shoes sold to the purchaser. For example, the seller may move a computing device, for example, a cell phone, near the tag of the right shoe. The computing device may energize the tag by generating an RF signal which may cause the tag to send it's id to the cell phone. This action may also cause an application to launch on the resellers computing device and the computing device may receive the right shoe's tag id which may be recorded by the computing device. The reseller may move the computing device to the tag of the left shoe which may cause the tag of the left shoe to send its id to the phone which can then record the id of the tag of the left shoe. The application can then send the pair of ids to a computer which has access to the manufacturer's authentication table where the computer compares the tag ids uploaded by the reseller to the authentication table. If the pair of ids matches a pair of ids in the authentication table then the computer would send a message back to the reseller indicating the goods are authentic. If the pair of ids is not present in the manufacturer's authentication table, then the computer sends a message to the reseller that the pair of shoes is not authenticated. For example, if the right shoe's tag had an identification number of 0003 and the left shoe's tag had an identification number of 0004, as shown in the authentication table of FIG. 4, then the pair of shoes would be authenticated since this pair is present in the manufacturer's authentication table. However, if the shoe's right tag had an identification number of 0003 and the left shoe had an identification number of 0005 then the pair of shoes would not be authenticated since this pair of ids is not present in the manufacturer's identification table.

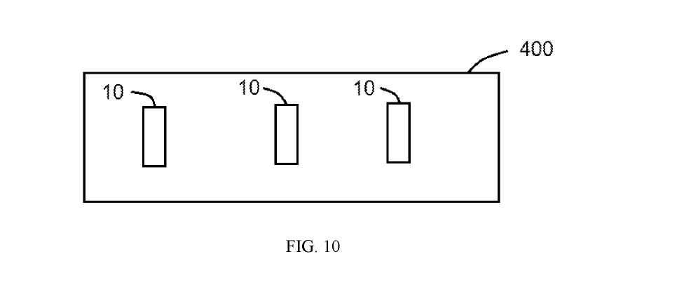

Although the above examples illustrate the authentication table is comprised of pairs of id's, this is not intended to limit the invention as the inventive concepts can implemented with more than two tags. For example, FIG. 9 illustrates an authentication table for a product 400 which may be comprised of multiple parts where three of the part are tagged with NFC enabled tags 10 as shown in FIG. 10. In this nonlimiting example embodiment, a user may move a computing device near a first tag, then a second tag, and then to a third tag which causes each of the tags 10 to send their unique id's to the computing device. The computing device may then upload the three id's to a computer which compares the three id's to the authentication table. If all three ids are associated with each other in the association table, then the computer may indicate the product is authentic, if the computer does not find the three ids associated with each other in the authentication table, then the computer would send a message indicating the product is not authentic. For example, if the first tag has an id of 0001, the second tag has an id of 0002, and the third tag has an id of 0003 then the computer would determine the product is authentic since the triple ids 001, 002, and 003 are associated with each other in the authentication table. However, if the first tag has an id of 0001, the second tag has an id of 0002, and the third tag has an id of 0004 then the product would not be authenticated since the triple ids 001, 002, and 004 do not constitute an authenticated group as found in the authentication table. As one skilled in the art would readily appreciate, the instant example shows an authentication table that associates three tag ids as one associated group, however the invention can easily be expanded to products which use more than three tags.

In example embodiments the method of authenticating a good may be implemented in various ways. For example, in one method the application residing on the computing device 30 may prompt the user to use the computing device 30 to obtain an identifier from a second tag and then send the first identifier and the second identifier to the computer 50 for authentication. In the alternative, the application, after receiving the first identifier from the first tag, may send the first identifier to computer 50. Computer 50 may then look up the associated id (or ids) and send the associated id (or ids) back to the computing device 30. The application, upon receiving the associated id (or ids) from the computer 50, may prompt the user to move the computing device to the second tag to obtain the second id. The application may then compare the second id to the one received from the computer 50. If the ids match, the application may indicate the product to which the tags are attached is authenticated. If they do not match, the application may indicate the product is not authenticated.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A method for providing dual factor authentication, the method comprising:
moving a computing device near a first tag;
receiving a first identifier from the first tag;
moving the computing device near a second tag;
receiving a second identifier from the second tag;
using the pair of identifiers to authenticate a product.

2. The method of claim 1, wherein first and second identifiers are unique identifiers.

3. The method of claim 1, further comprising:
energizing an antenna of the first tag to cause the first tag to send the first identifier to the computing device; and
energizing an antenna of the second tag to cause the second tag to send the second identifier to the computing device.

4. The method of claim 3, wherein the computing device and the first and second tags are configured for NFC.

5. The method of claim 4, wherein the first identifier and the second identifier are unique identifiers.

6. The method of claim 4, further comprising:
utilizing an authentication table to determine whether the first tag and the second tag have an association.

7. The method of claim 6, wherein the first and second identifiers are in the authentication table.

8. The method of claim 1, wherein the first and second tags are configured to automatically transmit their identifiers upon reception of an RF signal from the computing device.
